(19) United States
(12) Patent Application Publication
(10) Pub. No.: US 2017/0125915 A1
(43) Pub. Date: May 4, 2017

(54) ANTENNA WITH ABSORBENT DEVICE

(71) Applicants: Armel LEBAYON, Trignac (FR); Ludovic METRIAU, Trignac (FR); Denis TUAU, Trignac (FR)

(72) Inventors: Armel LEBAYON, Trignac (FR); Ludovic METRIAU, Trignac (FR); Denis TUAU, Trignac (FR)

(73) Assignee: Alcatel Lucent, Boulogne Billancourt (FR)

(21) Appl. No.: 15/129,523

(22) PCT Filed: Mar. 27, 2015
(86) PCT No.: PCT/IB2015/052266

§ 371 Date: Sep. 27, 2016

(30) Foreign Application Priority Data
Mar. 28, 2014 (EP) 14305449.2

(51) Int. Cl. H01Q 17/00; H01Q 1/42; H01Q 15/16

(52) U.S. Cl. CPC H01Q 17/008; H01Q 15/16; H01Q 1/42

(57) ABSTRACT

Antenna (1) presenting a concave reflector (10) defining a central axis of reflection z-z, comprising: a radome (20) adapted for mounting on said concave reflector (10), an absorbent device (50) adapted for absorbing electromagnetic waves, wherein a central axis y-y of the absorbent device (50), as being the axis perpendicular to the largest flat surface of the absorbent device (50), is substantially aligned along said central axis of reflection z-z.

### TECHNICAL FIELD

The present invention relates to a telecommunication antenna with a concave reflector having, for example, the shape of at least one parabola portion. These antennas, particularly microwave antennas, are commonly used in mobile communication networks. These antennas operate equally well in transmitter mode or in receiver mode, corresponding to two opposite directions of RF wave propagation.

### BACKGROUND OF INVENTION

This section introduces aspects that may be helpful in facilitating a better understanding of the invention. Accordingly, the statements of this section are to be read in this light and are not to be understood as admissions about what is in the prior art or what is not in the prior art.

Antennas may sometimes be associated with a radome, which is a structural, weatherproof enclosure that protects the antenna. The radome is constructed of material that minimally attenuates the electromagnetic signal transmitted or received by the antenna. A radome exhibits an impermeable protective surface closing off the space defined by the reflector, and if any the shroud, from the outside. This radome can be flexible or rigid, flat or not, and in any shape whatsoever. A circular rigid radome, the most commonly used kind today, offers the advantage of good resistance to the outside climate conditions, such as rain, wind, or snow.

In practice, microwave antennas are very sensitive to manufacturing imperfections, the presence of rivets, the machining tolerances of the pieces, which, together with the radome behavior (in particular the thickness or shape of the radome being out the dimensional tolerances), may all contribute to imperfections leading to a disturbed radiation pattern, particularly in the −40° to +40° angular area with an increasing of the sides lobes level. Sometimes, governments or standard-setting bodies for example the Federal Communications Commission (FCC), publish minimum standards that must be met for microwave antennas. There are cases where the above mentioned manufacturing imperfections push the performance envelope beyond set standards.

A solution to improve the antenna performance is to increase manufacturing tolerances or redesign the antenna. However, both solutions are expensive.

An alternative solution is sought.

### SUMMARY

According to the present invention, this object is achieved by an antenna presenting a concave reflector defining a central axis of reflection z-z, comprising:
a radome adapted for mounting on said concave reflector,
an absorbent device adapted for absorbing electromagnetic waves, wherein a central axis y-y of the absorbent device, as being the axis perpendicular to the largest flat surface of the absorbent device, is substantially aligned along said central axis of reflection z-z.

In view of the foregoing, an embodiment herein provides a radome adapted for mounting on an antenna presenting a concave reflector defining a central axis of reflection z-z, comprising a device positioned along said central axis z-z and adapted for absorbing electromagnetic waves.

This approach reduces the side lobes when addressing the problem of meeting the FCC mask guidelines.

It allows for the main antenna design and the existing machining tolerances to be kept while improving performances to ETSI or FCC regulation requirements.

Other embodiments also comprise an antenna wherein the central axis of reflection z-z traverses the geometric centre of the largest surface of the absorbent device in a direction y-y which is orthogonal to said surface.

Other embodiments also comprise an antenna wherein the absorbent device is fitted on the radome.

According to a first aspect, the absorbent device is fitted to the inside of the radome facing the main reflector.

According to a second aspect, the absorbent device is fitted to the outside of the radome facing outwardly.

According to a third aspect, the absorbent device is suspended inside the volume defined by the radome and the main reflector.

Other embodiments also comprise an antenna wherein the device has a length to width ratio of 1.5 to 2.5, preferably substantially equal to 2, wherein said length and width extends in a plane perpendicular to the central axis of reflection z-z.

Other embodiments also comprise an antenna wherein the absorbent device presents a thickness along the z-z direction comprised between 3-10 millimeters.

Other embodiments also comprise an antenna wherein the absorbent device presents a length comprised between 1/4^{th} and 1/6^{th} of the diameter of the radome, preferably substantially equal to 1/5^{th} of the diameter of the radome.

Other embodiments also comprise an antenna wherein the absorbent device presents a surface area along a surface orthogonal to the central axis of reflection z-z comprised between 1/60^{th} and 1/100^{th} of the surface area of the radome, preferably substantially equal to 1/80^{th} of the surface area of the radome.

Other embodiments also comprise an antenna wherein the absorbent device is constituted of a polyurethane foam homogeneously impregnated with carbon atoms.

A further solution to the object of the invention is given by a method of manufacturing an antenna presenting a concave reflector defining a central axis of reflection z-z, and comprising a radome adapted for mounting on said concave reflector, adapted to be fitted to an antenna, said method comprising the steps of:
providing a radome
fitting an absorbent device to said radome so that a central axis y-y of the absorbent device, as being the axis perpendicular to the largest flat surface of the absorbent device, is substantially aligned along said central axis of reflection z-z.

According to a first embodiment, said absorbent device is fitted to the inside of the radome facing the main reflector.

According to a second embodiment, said absorbent device is fitted to the outside of the radome facing outwardly.

According to a third embodiment, said absorbent device is fitted to the radome so as to be suspended inside the volume defined by the radome and the main reflector.

### BRIEF DESCRIPTION OF THE FIGURES

These and other aspects of the embodiments herein will be better appreciated and understood when considered in conjunction with the following description and the accompanying drawings.

The embodiments herein will be better understood from the following detailed description with reference to the drawings, in which:

FIG. 1 illustrates a perspective view of an exemplary prior art antenna;

FIG. 2 illustrates a perspective view of the antenna of FIG. 1 fitted with a radome;

FIG. 3 illustrates a frequency response plot of an antenna according to FIGS. 1 and 2.

FIG. 4 illustrates a cutaway perspective view of an antenna according to an embodiment;

FIGS. 5A-5D illustrate non limiting embodiments of absorbing devices according to embodiments;

FIG. 6. Illustrates a frequency response plot of an antenna fitted with an absorbent device.

It is to be noted that the figures are not drawn to scale.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

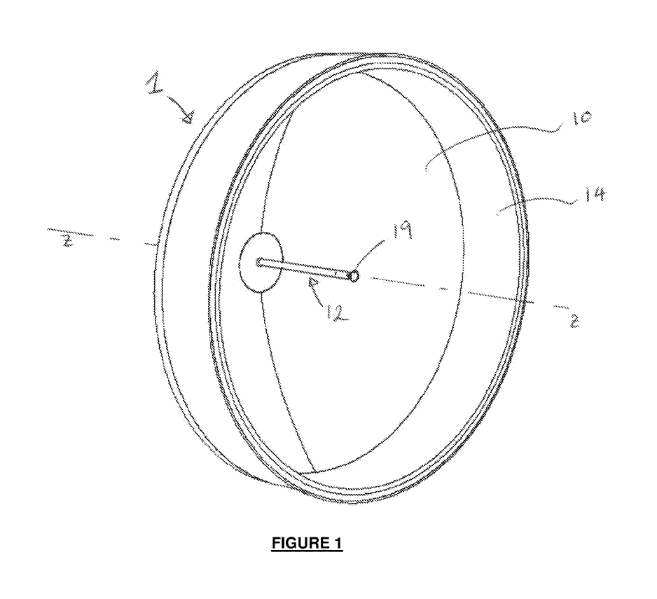

FIG. 1 illustrates a backfire-feed antenna 1 comprising a parabolic dish-shaped main reflector 10 defining a central axis of reflection z-z, a circular waveguide 12 extending along central axis of reflection z-z, and a backfire feed 19 positioned along axis z-z at the free extremity of the waveguide 12. The backfire feed 19 is also sometimes referred to as a self-supported feed.

The backfire feed 19 comprises a dielectric block ending with a sub-reflector located at the focal region of the main reflector 10.

The main reflector 10 and circular waveguide 12 are constructed from conducting materials, for example metallic elements or alloys, for example aluminum.

The backfire feed 19 has for function to reflect incident waves to and from the main reflector 10, and as such may be made either of metallic material, or painted with a metallic paint.

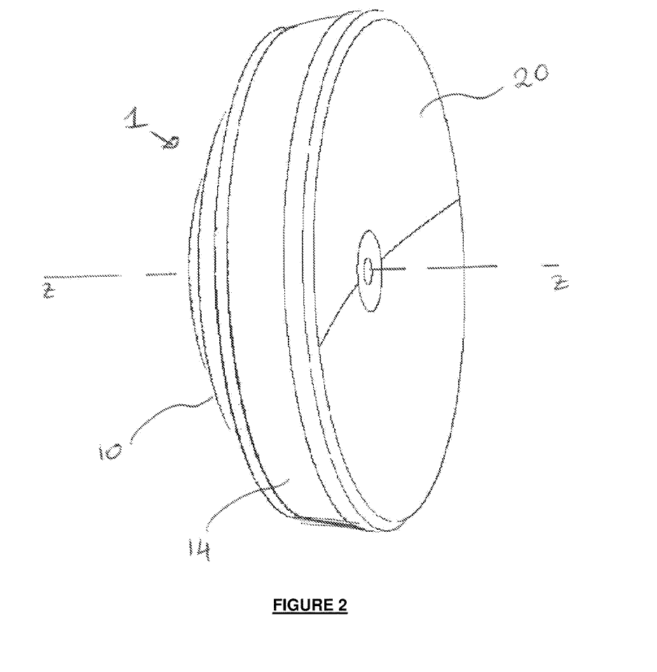

At FIG. 2, the antenna 1 of FIG. 1 is shown with a radome 20 attached along the circumferential edge of the main reflector 10 in such a way as to cover and protect the main reflector 10. A circumferential shield 14 may be coupled between the radome 20 and the periphery of the main reflector 10 to provide space for the extension of the feed 19 within the volume defined between the main reflector 10 and the radome 20.

The radome 20 can be made of a rigid or flexible material that allows as appropriate to obtain a flat, curved or tapered shape. Various materials may be used for the construction of the radome 20, such as a polymer (ABS, PS, PVC, PP) which may be injected or thermoformed. Such materials are chosen to keep attenuation of the signal transmitted and received to a minimum. The radome 20 may be formed for example of a multilayered material.

The radome thickness is calculated to be the most transparent to incident waves, and as such half-wavelength thickness or one-wavelength thickness is recommended, though a thickness of one wavelength is preferable since being mechanically stronger for field deployment.

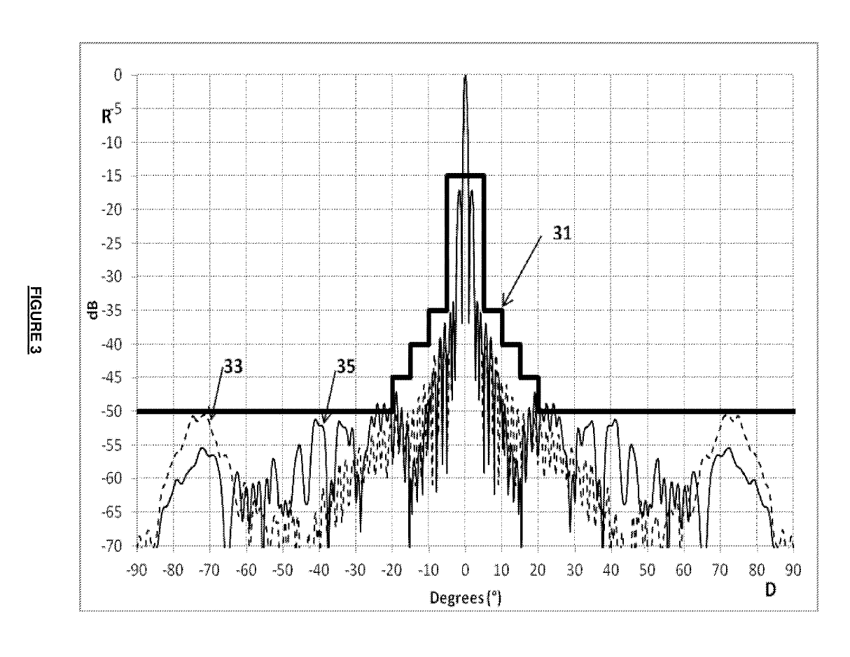

FIG. 3 illustrates a plot of the strength of the radiation pattern R (in dB) in vertical polarization against the angular direction D (in degree°) from a fixed point of the antenna 1 tuned to work in the E band frequency at approximately 71 GHz, in the case of small manufacturing imperfections being present in the antenna 1.

The radiation pattern illustrated by curve 33 represents the antenna 1 without a radome 20 fitted, and the radiation pattern illustrated by curve 35 is for the same antenna 1 fitted with a radome 20. The envelope 31 represents the radiation response limits as imposed by regulations FCC Part 101.115 and ETSI 302.217.4.2 v 1.5.1 Class 3 for E band antennas.

It is evident from this plot that the imperfections in the antenna 1 fitted with a radome damages the radiation pattern by increasing the side lobes in the 10 to 60 degree area. Nevertheless, it improves the pattern in the 60-90 degree area which is generally also important for the ETSI template.

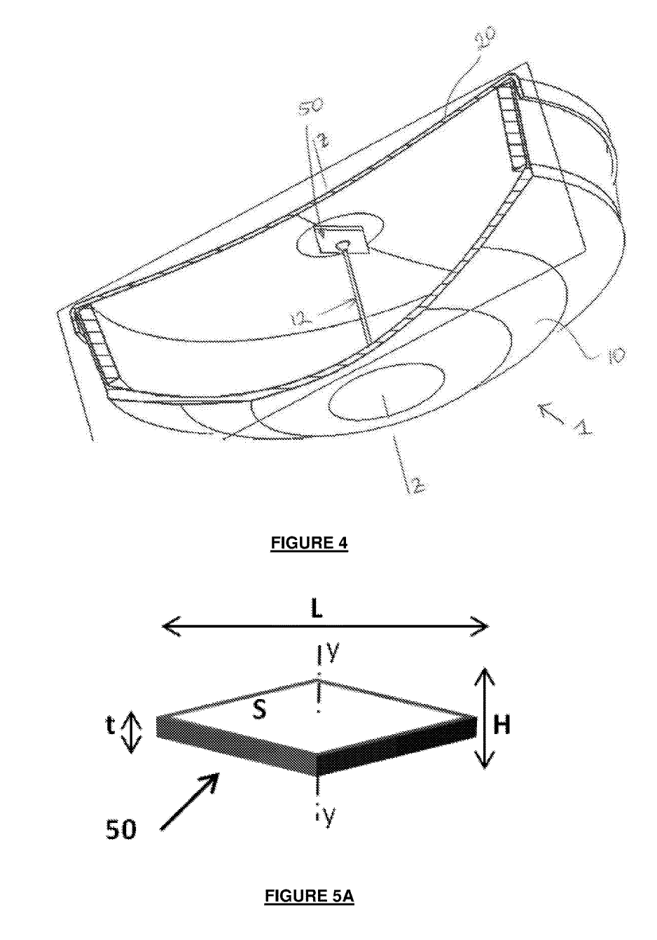

According to an aspect of the invention, the antenna 1 may be fitted with an absorbent device 50, and is illustrated at FIG. 4. The absorbent device 50 is to modify, absorb or control unwanted microwave radiating signal. Let us define a central axis y-y of the absorbent device 50 as being the axis perpendicular to the largest flat surface (also known as the face) of the absorbent device 50, and traversing the geometric centre of said surface.

The central axis y-y of the absorbent device 50 should be substantially aligned along the central axis of reflection z-z of the antenna 1 for best results in reducing the side lobes. Alignment tolerances of the order of 2 mm are accepted to avoid creating asymmetries in the radiation pattern R.

However, the absorbent device 50 could be fixed to the outside of the radome 20 facing outwardly, the inside of the radome 20 facing the main reflector 10, or indeed even suspended inside the volume defined by the radome 20 and the main reflector 10.

The absorbent device 50 may be constructed from wave-absorbent material for the wavelength of operation, such as a polyurethane foam homogeneously impregnated with carbon atoms. The concentration of carbon atoms will be that sufficient to provide an attenuation of the incident wave of greater than 15 dB.

Experiments have shown that the shape of the absorbent device 50 is best when it is elongated in a plane orthogonal to the central axis y-y.

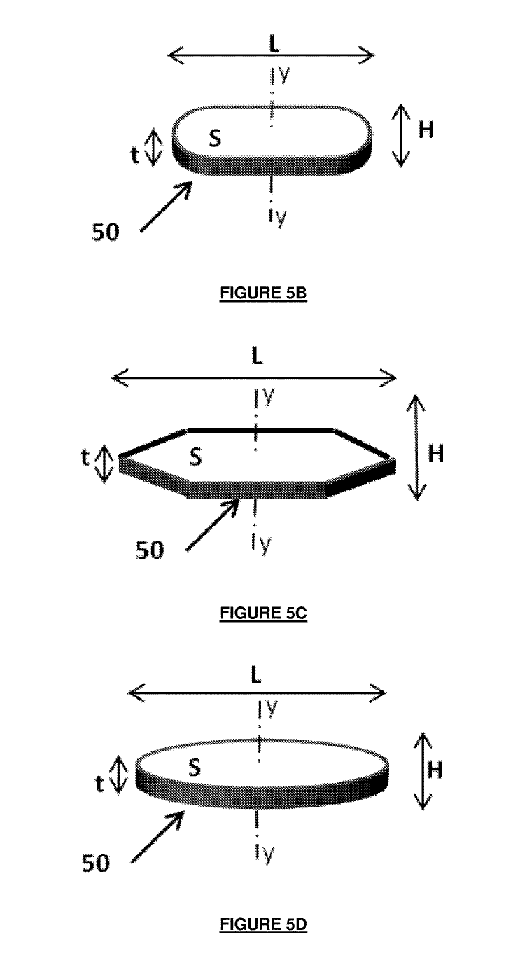

FIGS. 5A to 5D illustrate preferential shapes. In particular:
FIG. 5A illustrates a diamond shape in a plane orthogonal to the central axis y-y;
FIG. 5B illustrates an ovoid shape in a plane orthogonal to the central axis y-y;
FIG. 5C illustrates a stretched-hexagonal shape in a plane orthogonal to the central axis y-y;
FIG. 5D illustrates an oval shape in a plane orthogonal to the central axis y-y;

Prototype iteration, simulation and experimentation has shown that:
The thickness t along the y-y direction of the absorbent device 50 is to be greater than the wavelength of the incident wave, and preferably between 3 and 10 mm.
The ratio of length L to height H (ratio L/H) is to be comprised in a range of 1.5 to 2.5, preferably substantially equal to 2;
The length L is to be comprised in a range of 1/4 to 1/5 of the dimension of the diameter of the radome 20, preferably L is substantially equal to 1/5 of the diameter of the radome 20;
The total surface area S of the absorbent device 50 is to be comprised in a range of 1/60 to 1/100 of the total surface area of the radome 20, preferably substantially equal to 1/80 of the total surface area of the radome 20 surface.

The diameter of the radome 20 is defined to be the distance from the circumferential edge of the radome 10 to the other edge passing via the central axis z-z.

The above dimensions are guidelines, as exact dimension should be optimized by simulation to obtain the desired ETSI and FCC radio-electrical performance without compromising gain.

In another preferential variant of the absorbent device 50, the edges of the absorbent device 50 are preferably beveled or tapered, such that we can get a smooth transition with the surrounding air.

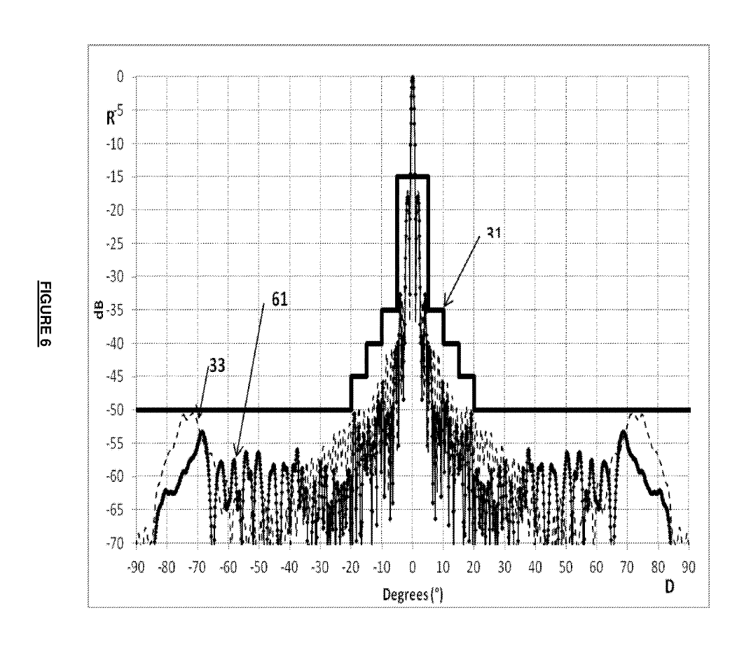

FIG. 6 illustrates a plot of the strength of the radiation pattern R (in dB) against the angular direction D (in degree°) from a fixed point of the antenna 1 tuned to emit in the 71 GHz frequency band, when fitted with the absorbent device 50.

The radiation pattern illustrated by curve 33 represents the antenna 1 without a radome 20 fitted, and the radiation pattern illustrated by curve 35 represents the antenna 1 fitted with a radome 20. The envelope 31 represents the radiation response of an FCC standard for 71 GHz antenna having a 1-foot (31 cm) diameter. Response curve 61 represents the angular response of the antenna 1 fitted with a radome 20 and an absorbent piece 50 according to a variant of FIGS. 5A to 5D.

Note that curves 31 and 33 are identical to those of FIG. 3.

The performance response of curve 61 is acceptable for the whole operational envelope.

1. Antenna presenting a concave reflector defining a central axis of reflection z-z, comprising:
a radome adapted for mounting on said concave reflector,
an absorbent device adapted for absorbing electromagnetic waves, wherein a central axis y-y of the absorbent device, as being the axis perpendicular to the largest flat surface of the absorbent device, is substantially aligned along said central axis of reflection z-z.

2. Antenna according to claim 1, wherein the central axis of reflection z-z traverses the geometric centre of the largest surface of the absorbent device in a direction y-y which is orthogonal to said surface.

3. Antenna according to claim 1, wherein the absorbent device is fitted on the radome.

4. Antenna according to claim 3, wherein the absorbent device is fitted to the inside of the radome facing the main reflector.

5. Antenna according to claim 3, wherein the absorbent device is fitted to the outside of the radome facing outwardly.

6. Antenna according to claim 1, wherein the absorbent device is suspended inside the volume defined by the radome and the main reflector.

7. Antenna according to claim 1, wherein the device has a length to width ratio of 1.5 to 2.5, wherein said length and width extends in a plane perpendicular to the central axis of reflection z-z.

8. Antenna according to claim 1, wherein the absorbent device presents a thickness along the z-z direction comprised between 3-10 millimeters.

9. Antenna according to claim 1, wherein the absorbent device presents a length comprised between 1/4^{th} and 1/6^{th} of the diameter of the radome.

10. Antenna according to claim 1, wherein the absorbent device presents a surface area along a surface orthogonal to the central axis of reflection z-z comprised between 1/60^{th} and 1/100^{th} of the surface area of the radome.

11. Antenna according to claim 1, wherein the absorbent device is constituted of a polyurethane foam homogeneously impregnated with carbon atoms.

12. Method of manufacturing an antenna presenting a concave reflector defining a central axis of reflection z-z, and comprising a radome adapted for mounting on said concave reflector, said method comprising:
providing a radome
fitting an absorbent device to said radome so that a central axis y-y of the absorbent device, as being the axis perpendicular to the largest flat surface of the absorbent device, is substantially aligned along said central axis of reflection z-z.

13. Method of manufacturing an antenna according to claim 12, wherein said absorbent device is fitted to the inside of the radome facing the main reflector.

14. Method of manufacturing an antenna according to claim 12, wherein said absorbent device is fitted to the outside of the radome facing outwardly.

15. Method of manufacturing an antenna according to claim 12, wherein said absorbent device is fitted to the radome so as to be suspended inside the volume defined by the radome and the main reflector.
